(19) United States
(12) Patent Application Publication
(10) Pub. No.: US 2009/0149565 A1
(43) Pub. Date: Jun. 11, 2009

(54) Method for Making High Performance Mixed Matrix Membranes

(76) Inventors: Chunqing Liu, Schaumburg, IL (US); Stephen T. Wilson, Libertyville, IL (US); Stephen C. Houdek, Des Plaines, IL (US); David A. Lesch, Hoffman Estates, IL (US)

Correspondence Address: HONEYWELL INTERNATIONAL INC;PATENT SERVICES, 101 COLUMBIA DRIVE, P O BOX 2245 MAIL STOP AB/2B, MORRISTOWN, NJ, 07962, US

(21) Appl. No.: 11/954,013

(22) Filed: Dec. 11, 2007

(51) Int. Cl. C08F 16/06; C08F 283/04; C08G 18/00; C08G 63/91; C08F 283/00; C08J 3/28

(52) U.S. Cl. 522/148; 525/50; 525/56; 525/540; 525/420; 525/452; 525/419; 525/535; 525/471; 525/523

(57) ABSTRACT

The present invention discloses method for making defect-free high performance mixed matrix membranes (MMMs) containing a continuous polymer matrix and dispersed molecular sieves such as AlPO-14 or UZM-5. These MMMs can be used for separations. The novel method for making defect-free high performance MMMs comprises: post treating the MMM at a temperature ≧150° C. This new method results in a MMM with either no macrovoids or voids of less than 5 angstroms at the interface of the continuous polymer matrix and the molecular sieves. The MMMs are in the form of symmetric dense film, thin-film composite (TFC), asymmetric flat sheet or asymmetric hollow fiber. These MMMs have good flexibility and high mechanical strength, and exhibit high carbon dioxide/methane (CO₂/CH₄) selectivity and high CO₂ permeance for CO₂/CH₄ separation. The MMMs are suitable for a variety of liquid, gas, and vapor separations.

### BACKGROUND OF THE INVENTION

This invention pertains to an approach for making defect-free high performance mixed matrix membranes (MMMs) containing molecular sieves and a continuous polymer matrix. More particularly, the invention involves the use of a heat treatment of a mixed matrix membrane to improve its performance.

Current commercial cellulose acetate (CA) polymer membranes for natural gas upgrading need improvement to remain competitive in the natural gas processing business. It is highly desirable to provide an alternate cost-effective new membrane with higher selectivity and permeability than CA membrane for CO₂/CH₄ as well as other gas and vapor separations.

Gas separation processes with membranes have undergone a major evolution since the introduction of the first membrane-based industrial hydrogen separation process about two decades ago. The design of new materials and efficient methods will further advance the membrane gas separation processes within the next decade.

The gas transport properties of many glassy and rubbery polymers have been measured as part of the search for materials with high permeability and high selectivity for potential use as gas separation membranes. Unfortunately, an important limitation in the development of new membranes for gas separation applications is a well-known trade-off between permeability and selectivity of polymers. By comparing the data of hundreds of different polymers, Robeson demonstrated that selectivity and permeability seem to be inseparably linked to one another, in a relation where selectivity increases as permeability decreases and vice versa.

Despite concentrated efforts to tailor polymer structure to improve separation properties, current polymeric membrane materials have seemingly reached a limit in the trade-off between productivity and selectivity. For example, many polyimide and polyetherimide glassy polymers such as Ultem® 1000 have much higher intrinsic CO₂/CH₄ selectivities (α_{CO2/CH4}) (˜30 at 50° C. and 690 kPa (100 psig) pure gas tests) than that of cellulose acetate (˜22), which are more attractive for practical gas separation applications. These polyimide and polyetherimide polymers, however, do not have outstanding permeabilities attractive for commercialization compared to current commercial cellulose acetate membrane products, in agreement with the trade-off relationship reported by Robeson. On the other hand, some inorganic membranes such as ZSM-58 zeolite, SAPO-34 molecular sieve, and carbon molecular sieve membranes offer much higher permeability and selectivity than polymeric membranes for separations, but are expensive and difficult for large-scale manufacture. Therefore, it is highly desirable to provide an alternate cost-effective membrane with enhanced separation properties.

Based on the need for a more efficient membrane than polymer and inorganic membranes, a new type of membrane, mixed matrix membranes (MMMs), has been developed recently. MMMs are hybrid membranes containing inorganic fillers such as molecular sieves dispersed in a polymer matrix.

Mixed matrix membranes have the potential to achieve higher selectivity with equal or greater permeability compared to existing polymer membranes, while maintaining their advantages such as low cost and easy processability. Much of the research conducted to date on mixed matrix membranes has focused on the combination of a dispersed solid molecular sieving phase, such as molecular sieves or carbon molecular sieves, with an easily processed continuous polymer matrix. For example, see U.S. Pat. No. 6,626,980; US 2005/0268782; US 2007/0022877; and U.S. Pat. No. 7,166,146. The sieving phase in a solid/polymer mixed matrix scenario can have a selectivity that is significantly larger than the pure polymer. Therefore, in theory the addition of a small volume fraction of molecular sieves to the polymer matrix will increase the overall separation efficiency significantly. Typical inorganic sieving phases in MMMs include various molecular sieves, carbon molecular sieves, and traditional silica. Many organic polymers, including cellulose acetate, polyvinyl acetate, polyetherimide (commercially Ultem®), polysulfone (commercial Udel®), polydimethylsiloxane, polyethersulfone, and several polyimides (including commercial Matrimid®), have been used as the continuous phase in MMMs.

While the polymer “upper-bound” curve has been surpassed using solid/polymer MMMs, there are still many issues that need to be addressed for large-scale industrial production of these new types of MMMs. For example, for most of the molecular sieve/polymer MMMs reported in the literature, voids and defects at the interface of the inorganic molecular sieves and the organic polymer matrix were observed due to the poor interfacial adhesion and poor materials compatibility. These voids, that are much larger than the penetrating molecules, resulted in reduced overall selectivity of the MMMs. Research has shown that the interfacial region, which is a transition phase between the continuous polymer and dispersed sieve phases, is of particular importance in forming successful MMMs.

Most recently, significant research efforts have been focused on materials compatibility and adhesion at the inorganic molecular sieve/polymer interface of the MMMs in order to achieve separation property enhancements over traditional polymers. For example, Kulkarni et al. and Marand et al. reported the use of organosilicon coupling agent functionalized molecular sieves to improve the adhesion at the sieve particle/polymer interface of the MMMs. See U.S. Pat. No. 6,508,860 and U.S. Pat. No. 7,109,140. This method, however, has a number of drawbacks including: 1) prohibitively expensive organosilicon coupling agents; 2) very complicated time consuming molecular sieve purification and organosilicon coupling agent recovery procedures after functionalization. Therefore, the cost of making such MMMs having organosilicon coupling agent functionalized molecular sieves in a commercially viable scale can be very expensive. Most recently, Kulkarni et al. also reported the formation of MMMs with minimal macrovoids and defects by using electrostatically stabilized suspensions. See US 2006/0117949.

Commercially available polymer membranes, such as cellulose acetate and polysulfone membranes, have an asymmetric structure with a thin defect-free dense selective layer (<1 μm) on top of a microporous nonselective support layer. As a consequence, a key challenge for making asymmetric mixed matrix membranes in the form of flat-sheet (or spiral wound) or hollow fiber is to minimize the voids and defects induced by the unfavorable interaction at the molecular sieve/polymer interface. The size of these voids and defects is normally in the range of 0.5 nanometers to tens of nanometers and cannot be completely sealed only by silicone rubber coating alone. Jiang et al have investigated the effectiveness of heat treatment and surface coating in healing the mixed matrix hollow fiber membranes. See Jiang, et al., J. MEMBR. SCI., 2006, 276, 113. However, they demonstrated two-step coating before heat treatment is necessary to seal the voids and defects in the thin selective layer of the hollow fiber mixed matrix membranes.

Despite all the research efforts, there is still a need for developing novel approaches to make high performance mixed matrix membranes with improved compatibility and adhesion at the molecular sieve/polymer interface.

### SUMMARY OF THE INVENTION

This invention pertains to a novel method for making defect-free high performance mixed matrix membranes (MMMs) by improving the properties of the MMMs through a post treating heating step. This invention also pertains to the use of these MMMs for separations such as CO₂ removal from natural gas.

The present invention discloses a novel approach for making defect-free high performance mixed matrix membranes (MMMs) containing a continuous polymer matrix and dispersed molecular sieves such as AlPO-14 or UZM-5. The present invention also discloses the use of these MMMs for separations. The novel method for making defect-free high performance MMMs comprises: (a) dispersing molecular sieve particles in a solvent mixture; (b) dissolving a suitable polymer in molecular sieve slurry to functionalize the surface of the molecular sieve particles; (c) dissolving one or two polymers that serves as a continuous polymer matrix in the polymer functionalized molecular sieve slurry to form a stable MMM casting dope; (d) fabricating a MMM in a form of symmetric dense film, thin-film composite, asymmetric flat sheet, or asymmetric hollow fiber using the MMM casting dope; (e) coating the selective layer surface of the MMM with a thin layer of material such as a fluoro-polymer, a thermally curable silicone rubber, or a UV radiation curable silicone rubber. This coating step is not necessary for making symmetric mixed matrix dense films; (f) post treating the MMM at a temperature ≧150° C. The heat treatment may be in a range from about 150° to about 300° C. This new method results in a MMM with either no macrovoids or voids of less than 5 angstroms (Å) at the interface of the continuous polymer matrix and the molecular sieves. The MMMs prepared using the current method are in the form of symmetric dense film, thin-film composite, asymmetric flat sheet or asymmetric hollow fiber. These MMMs have good flexibility and high mechanical strength, and exhibit high carbon dioxide/methane (CO₂/CH₄) selectivity and high CO₂ permeance (or permeability) for CO₂/CH₄ separation.

The molecular sieves dispersed in the MMMs provided in this invention have selectivity and/or permeability that are significantly higher than the continuous polymer matrix for separations. Addition of a small weight percent of molecular sieves to the polymer matrix increases the overall separation efficiency. The molecular sieves used in the MMMs of current invention include microporous and mesoporous molecular sieves, carbon molecular sieves, porous metal-organic frameworks (MOFs), zeolite imidazolate frameworks (ZIFs), or covalent organic frameworks (COFs). The microporous molecular sieves are selected from, but are not limited to, small pore microporous alumino-phosphate molecular sieves such as AlPO-18 (3.8×3.8 Å), AlPO-14 (1.9×4.6 Å, 2.1×4.9 Å, and 3.3×4.0 Å), AlPO-52 (3.2×3.8 Å, 3.6×3.8 Å), and AlPO-17 (5.1×3.6 Å), small pore microporous aluminosilicate molecular sieves such as UZM-5 (3.2×3.2 Å, 3.6×4.4 Å), UZM-25 (2.5×4.2 Å, 3.1×4.7 Å), and UZM-9 (3.8×3.8 Å), small pore microporous silico-alumino-phosphate molecular sieves such as SAPO-34 (3.8×3.8 Å), SAPO-56 (3.4×3.6 Å), and mixtures thereof.

The polymer that serves as the continuous matrix is selected from rigid, glassy organic polymers with a carbon dioxide over methane selectivity of at least about 8, and more preferably at least about 15 at 50° C. and 690 kPa (100 psig) pure carbon dioxide or methane testing pressure.

The method of the current invention for producing defect-free high performance MMMs is suitable for large scale membrane production and can be integrated into commercial polymer membrane manufacturing processes.

The invention provides a process for separating at least one gas from a mixture of gases using the MMMs prepared in accordance with the present invention, the process comprising first providing an MMM prepared in accordance with the process described herein. The MMM comprises a molecular sieve filler material uniformly dispersed in a continuous polymer matrix which is permeable to said at least one gas. The mixture then contacts one side of the MMM to cause this at least one gas to permeate the MMM. A permeate gas composition comprising a portion of this at least one gas which permeated the membrane is removed from the opposite side of the membrane.

The MMMs described in the present invention are suitable for a variety of liquid, gas, and vapor separations such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin (e.g. propylene/propane), iso/normal paraffins separations, and other light gas mixture separations.

### DETAILED DESCRIPTION OF THE INVENTION

Mixed matrix membrane (MMM) containing dispersed molecular sieve fillers in a continuous polymer matrix may retain polymer processability and improve selectivity for separations due to the superior molecular sieving and sorption properties of the molecular sieve materials. The MMMs have received worldwide attention during the last two decades. For most cases, however, aggregation of the molecular sieve particles in the polymer matrix and the poor adhesion at the interface of molecular sieve particles and the polymer matrix in MMMs that result in poor mechanical and processing properties and poor permeation performance still need to be addressed. Material compatibility and good adhesion between the polymer matrix and the molecular sieve particles are needed to achieve enhanced selectivity of the MMMs. Poor adhesion that results in voids and defects around the molecular sieve particles that are larger than the pores inside the molecular sieves decrease the overall selectivity of the MMM by allowing the species to be separated to bypass the pores of the molecular sieves.

The present invention pertains to a novel method for making defect-free high performance mixed matrix membranes (MMMs). This invention also pertains to the use of these MMMs for separations such as CO₂ removal from natural gas. The term “mixed matrix” as used in this invention means that the membrane has a selective permeable layer which comprises a continuous polymer matrix and discrete molecular sieve particles dispersed throughout the continuous polymer matrix.

The method used for making defect-free MMMs described in the current invention comprises dispersing molecular sieve particles in a solvent mixture; then dissolving a suitable polymer in the molecular sieve slurry to functionalize the surface of the molecular sieve particles; dissolving one or two polymers that serve as a continuous polymer matrix in the polymer functionalized molecular sieve slurry to form a stable MMM casting dope; fabricating a MMM in a form of symmetric dense film, thin-film composite, asymmetric flat sheet, or asymmetric hollow fiber using the MMM casting dope; coating the selective layer surface of the MMM with a thin layer of material such as a fluoro-polymer, a thermally curable silicone rubber, or a UV radiation curable silicone rubber (this coating step is not necessary for making symmetric mixed matrix dense films); and then post treating the MMM at a temperature ≧150° C. The heat treatment may be in a range from about 150° C. to about 300° C. The last step of heating the mixed matrix membrane is a key step which not only further reduces the microvoids between polymer and molecular sieve particles, but also eliminates the delamination between the thin coating layer and the thin selective mixed matrix layer. This method results in a MMM with either no macrovoids or voids of less than 5 Å at the interface of the continuous polymer matrix and the molecular sieves. The MMMs prepared using the current method can be in the form of symmetric dense film, thin-film composites (TFC), asymmetric flat sheets or asymmetric hollow fibers. These MMMs have good flexibility and high mechanical strength, and exhibit high carbon dioxide/methane (CO₂/CH₄) selectivity and high CO₂ permeance for CO₂/CH₄ separation.

The molecular sieves dispersed in the MMMs provided in this invention have selectivity and/or permeability that are significantly higher than the continuous polymer matrix for separations. Addition of a small weight percent of molecular sieves to the polymer matrix, therefore, increases the overall separation efficiency. The molecular sieves used in the MMMs of the current invention include microporous and mesoporous molecular sieves, carbon molecular sieves, porous metal-organic frameworks (MOFs), zeolite imidazolate frameworks (ZIFs), or covalent organic frameworks (COFs).

Microporous molecular sieve materials are microporous crystals with pores of a well-defined size ranging from about 0.2 to 2 nm. This discrete porosity provides molecular sieving properties to these materials which have found wide applications as catalysts and sorption media. Molecular sieves have framework structures which may be characterized by distinctive wide-angle X-ray diffraction patterns. Molecular sieve structure types can be identified by their structure type code as assigned by the IZA Structure Commission following the rules set up by the IUPAC Commission on Zeolite Nomenclature. Zeolites are a subclass of molecular sieves based on an aluminosilicate composition. Non-zeolitic molecular sieves are based on other compositions such as aluminophosphates, silico-aluminophosphates, and silica. Molecular sieves of different chemical compositions can have the same framework structure. Microporous molecular sieve materials may be characterized as being “large pore”, “medium pore” or “small pore” molecular sieves. As used in the present invention, the term “large pore” refers to molecular sieves which have greater than or equal to 12-ring openings in their framework structure, the term “medium pore” refers to molecular sieves which have 10-ring openings in their framework structure, and the term “small pore” refers to molecular sieves which have less than or equal to 8-ring openings in their framework structure. In addition, as used in the present invention, the term “1-dimensional” or “1-dimensional pores” refers to the fact that the pores in the molecular sieves are essentially parallel and do not intersect. The terms “2-dimensional”, “3-dimensional”, “2-dimensional pores”, and “3-dimensional pores” refer to pores which intersect with each other. The molecular sieves of the present invention may be 1-dimensional, 2-dimensional, or 3-dimensional.

A pore system of a molecular sieve is generally characterized by a major and a minor dimension. For example, molecular sieves having the IUPAC structure of DDR has a major diameter of 4.4 Å and a minor diameter of 3.6 Å. In some cases, molecular sieves can have 1, 2, or even 3 different pore systems. For the high Si/Al molar ratio, low acidity, small pore molecular sieves used in the present invention, the pore system with the largest minor free crystallographic diameter will effectively control the diffusion rate through the molecular sieves. For example, molecular sieves having a CDO structure have two pore systems with major and minor diameters of 2.5×4.2 Å and 3.1×4.7 Å. The controlling effective minor diameter of this CDO type of molecular sieves in the MMMs in the present invention is the pore system having the largest minor diameter, i.e., the pore system having the major and minor crystallographic free diameters of 3.1×4.7 Å. Accordingly, as used in the present invention, the largest minor crystallographic free diameter for the CDO structure is 3.1 Å.

Preferably, the microporous molecular sieves used for the preparation of the MMMs are small pore molecular sieves such as SAPO-34, Si-DDR, UZM-9, AlPO-14, AlPO-34, AlPO-17, SSZ-62, SSZ-13, AlPO-18, LTA, ERS-12, CDS-1, MCM-65, MCM-47, 4A, 5A, UZM-5, UZM-9, UZM-25, AlPO-34, SAPO-44, SAPO-47, SAPO-17, CVX-7, SAPO-35, SAPO-56, AlPO-52, SAPO-43, medium pore molecular sieves such as silicalite-1, and large pore molecular sieves such as NaX, NaY, and CaY.

More preferably, the microporous molecular sieves are selected from, but are not limited to, small pore microporous alumino-phosphate molecular sieves such as AlPO-18 (3.8×3.8 Å), AlPO-14 (1.9×4.6 Å, 2.1×4.9 Å, and 3.3×4.0 Å), AlPO-52 (3.2×3.8 Å, 3.6×3.8 Å), and AlPO-17 (5.1×3.6 Å), small pore microporous aluminosilicate molecular sieves such as UZM-5 (3.2×3.2 Å, 3.6×4.4 Å), UZM-25 (2.5×4.2 Å, 3.1×4.7 Å), and small pore microporous UZM-9 (3.8×3.8 Å), silico-alumino-phosphate molecular sieves such as SAPO-34 (3.8×3.8 Å), SAPO-56 (3.4×3.6 Å), and mixtures thereof. The small pore microporous molecular sieves of this invention are capable of separating mixtures of molecular species based on the molecular size or kinetic diameter (molecular sieving mechanism). The separation is accomplished by the smaller molecular species entering the intracrystalline void space while the larger species is more restricted in movement or excluded altogether.

Another type of molecular sieves used in the MMMs provided in this invention are mesoporous molecular sieves. Examples of preferred mesoporous molecular sieves include MCM-41, SBA-15, and surface functionalized MCM-41 and SBA-15, etc.

Metal-organic frameworks (MOFS) can also be used as the molecular sieves in the MMMs described in the present invention. MOFs are a new type of highly porous crystalline zeolite-like material and are composed of rigid organic units coordinated to metal-ligands or clusters. They possess vast accessible surface areas per unit mass. See Yaghi et al., SCIENCE, 295: 469 (2002); Yaghi et al., MICROPOR. MESOPOR. MATER., 73: 3 (2004); Dybtsev et al., ANGEW. CHEM. INT. ED., 43: 5033 (2004). MOF-5 is a prototype of a new class of porous materials constructed from octahedral Zn—O—C clusters and benzene links. Most recently, Yaghi et al. reported the systematic design and construction of a series of frameworks (IRMOF) that have structures based on the skeleton of MOF-5, wherein the pore functionality and size have been varied without changing the original cubic topology. For example, IRMOF-1 (Zn₄O(R₁-BDC)₃) has the same topology as that of MOF-5, but was synthesized by a simplified method. In 2001, Yaghi et al. reported the synthesis of a porous metal-organic polyhedron (MOP) Cu₂₄(m-BDC)₂₄(DMF)₁₄(H₂O)₅₀(DMF)₆(C₂H₅OH)₆, termed “α-MOP-1” and constructed from 12 paddle-wheel units bridged by m-BDC to give a large metal-carboxylate polyhedron. See Yaghi et al., J. AM. CHEM. SOC., 123: 4368 (2001). These MOF, IR-MOF and MOP materials exhibit analogous behaviour to that of conventional microporous materials such as large and accessible surface areas, with interconnected intrinsic micropores. Moreover, they may reduce the hydrocarbon fouling problem of the polyimide membranes due to relatively larger pore sizes than those of zeolite materials. MOF, IR-MOF and MOP materials are also expected to allow the polymer to infiltrate the pores, which would improve the interfacial and mechanical properties and would in turn affect permeability. Therefore, these MOF, IR-MOF and MOP materials (all termed “MOF” herein this invention) are used as molecular sieves in the preparation of the MMMs in the present invention.

The particle size of the molecular sieves dispersed in the continuous polymer matrix of the MMMs in the present invention should be small enough to form a uniform dispersion of the particles in the concentrated suspensions from which the MMMs will be fabricated. The median particle size should be less than about 10 μm, preferably less than 5 μm, and more preferably less than 1 μm. Most preferably, nano-molecular sieves (or “molecular sieve nanoparticles”) should be used in the MMMs of the current invention.

Nano-molecular sieves described herein are sub-micron size molecular sieves with particle sizes in the range of 5 to 1000 nm. Nano-molecular sieve selection for the preparation of the MMMs includes screening the dispersity of the nano-molecular sieves in organic solvent, the porosity, particle size, and surface functionality of the nano-molecular sieves, the adhesion or wetting property of the nano-molecular sieves with the polymer matrix. Nano-molecular sieves for the preparation of the MMMs should have suitable pore size to allow selective permeation of a smaller sized gas, and also should have appropriate particle size in the nanometer range to prevent defects in the membranes. The nano-molecular sieves should be easily dispersed without agglomeration in the polymer matrix to maximize the transport property.

The nano-molecular sieves described herein are synthesized from initially clear solutions. Representative examples of nano-molecular sieves suitable to be incorporated into the MMMs described herein include silicalite-1, SAPO-34, Si-MTW, Si-BEA, Si-MEL, LTA, FAU, Si-DDR, AlPO-14, AlPO-34, SAPO-56, AlPO-52, AlPO-18, SSZ-62, UZM-5, UZM-9, UZM-25, and MCM-65.

In the present invention, the outside surfaces of the molecular sieve particles dispersed in the MMMs are functionalized by a suitable polymer which has good compatibility (or miscibility) with the continuous polymer matrix (e.g., polyethersulfone (PES) can be used to functionalize the molecular sieves when Matrimid polyimide is used as the continuous polymer matrix in the MMM). The surface functionalization of the molecular sieves results in the formation of either polymer-O-molecular sieve covalent bonds via reactions between the hydroxyl (—OH) groups on the surfaces of the molecular sieves and the hydroxyl (—OH) groups at the polymer chain ends or at the polymer side chains of the molecular sieve stabilizers such as PES or hydrogen bonds between the hydroxyl groups on the surfaces of the molecular sieves and the functional groups such as ether groups on the polymer chains. The surfaces of the molecular sieves contain many hydroxyl groups attached to silicon, aluminum (if present) and phosphate (if present). These hydroxyl groups on the molecular sieves can affect long-term stability of the MMM casting dopes and phase separation kinetics of the MMMs. The stability of the concentrated suspensions refers to the characteristic of the molecular sieve particles remaining homogeneously dispersed in the suspension. A key factor in determining whether aggregation of molecular sieve particles can be prevented and a stable suspension formed is the compatibility of these molecular sieve surfaces with the polymer matrix and the solvents in the casting dopes. The functionalization of the surfaces of the molecular sieves using a suitable polymer described in the present invention provides good compatibility and adhesion at the molecular sieve/polymer interface.

Preferably, the polymers used to functionalize the molecular sieves contain functional groups such as hydroxyl or amino groups that can form hydrogen bonding with the hydroxyl groups on the surfaces of the molecular sieves. More preferably, the polymers used to functionalize the molecular sieve contain functional groups such as hydroxyl or isocyanate groups that can react with the hydroxyl groups on the surface of the molecular sieves to form polymer-O-molecular sieve covalent bonds. Thus, good adhesion between the molecular sieves and polymer is achieved. Representatives of such polymers are hydroxyl or amino group-terminated polymers such as polyethersulfones (PESs), sulfonated PESs, cellulose triacetate, cellulose acetate, poly(vinyl esters) such as poly(vinyl acetate) and poly(vinyl propionate), poly(vinyl ethers), polyethers such as hydroxyl group-terminated poly(ethylene oxide)s, amino group-terminated poly(ethylene oxide)s, or isocyanate group-terminated poly(ethylene oxide)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(allyl amine)s, poly(vinyl amine)s, and polyetherimides such as Ultem (or Ultem 1000) sold under the trademark Ultem®, manufactured by Sabic Innovative Plastics, as well as hydroxyl group-containing glassy polymers such as cellulosic polymers including cellulose acetate, cellulose triacetate, cellulose acetate-butyrate, cellulose propionate, ethyl cellulose, methyl cellulose, and nitrocellulose.

The weight ratio of the molecular sieves to the polymer used to functionalize the molecular sieves in the MMMs of the current invention can be within a broad range, but not limited to, from about 1:2 to 100:1 based on the polymer used to functionalize the molecular sieves, i.e. 50 weight parts of molecular sieve per 100 weight parts of polymer used to functionalize the molecular sieves to about 100 weight parts of molecular sieve per 1 weight part of polymer used to functionalize the molecular sieves depending upon the properties sought as well as the dispersibility of a particular molecular sieve in a particular suspension. Preferably the weight ratio of the molecular sieves to the polymer used to functionalize the molecular sieves in the MMMs of the current invention is in the range from about 10:1 to 1:2.

The polymer that serves as the continuous polymer matrix in the MMM of the present invention provides a wide range of properties important for separations, and modifying it can improve membrane selectivity. A material with a high glass transition temperature (Tg), high melting point, and high crystallinity is preferred for most gas separations. Glassy polymers (i.e., polymers below their Tg) have stiffer polymer backbones and therefore let smaller molecules such as hydrogen and helium permeate the membrane more quickly and larger molecules such as hydrocarbons permeate the membrane more slowly. For the MMM applications in the present invention, it is preferred that the membrane fabricated from the pure polymer, which can be used as the continuous polymer matrix in MMMs, exhibits a carbon dioxide over methane selectivity of at least about 8, more preferably at least about 15 at 50° C. and 690 kPa (100 psig) pure carbon dioxide or methane testing pressure. Preferably, the polymer that serves as the continuous polymer matrix in the MMM of the present invention is a rigid, glassy polymer. The weight ratio of the molecular sieves to the polymer that serves as the continuous polymer matrix in the MMM of the current invention can be within a broad range from about 1:100 (1 weight part of molecular sieves per 100 weight parts of the polymer that serves as the continuous polymer matrix) to about 1:1 (100 weight parts of molecular sieves per 100 weight parts of the polymer that serves as the continuous polymer matrix) depending upon the properties sought as well as the dispersibility of the particular molecular sieves in the particular continuous polymer matrix.

Typical polymers that can serve as the continuous polymer matrix in the MMM can be selected from, but are not limited to, polysulfones; sulfonated polysulfones; polyethersulfones (PESs); sulfonated PESs; polyethers; polyetherimides such as Ultem (or Ultem 1000) sold under the trademark Ultem®, manufactured by Sabic Innovative Plastics, poly(styrenes), including styrene-containing copolymers such as acrylonitrilestyrene copolymers, styrene-butadiene copolymers and styrene-vinylbenzylhalide copolymers; polycarbonates; cellulosic polymers, such as cellulose acetate, cellulose triacetate, cellulose acetate-butyrate, cellulose propionate, ethyl cellulose, methyl cellulose, nitrocellulose; polyamides; polyimides such as Matrimid sold under the trademark Matrimid® by Huntsman Advanced Materials (Matrimid® 5218 refers to a particular polyimide polymer sold under the trademark Matrimid®) and P84 or P84HT sold under the tradename P84 and P84HT respectively from HP Polymers GmbH; polyamide/imides; polyketones, polyether ketones; poly(arylene oxide)) such as poly(phenylene oxide) and poly(xylene oxide); poly(esteramide-diisocyanate); polyurethanes; polyesters (including polyarylates), such as poly(ethylene terephthalate), poly(alkyl methacrylate)s, poly(acrylate)s, poly(phenylene terephthalate), etc.; polysulfides; polymers from monomers having alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl ester)s such as poly(vinyl acetate) and poly(vinyl propionate), poly(vinyl pyridine)s, poly(vinyl pyrrolidone)s, poly(vinyl ether)s, poly(vinyl ketone)s, poly(vinyl aldehyde)s such as poly(vinyl formal) and poly(vinyl butyral), poly(vinyl amide)s, poly(vinyl amine)s, poly(vinyl urethane)s, poly(vinyl urea)s, poly(vinyl phosphate)s, and poly(vinyl sulfate)s; polyallyls; poly(benzobenzimidazole)s; polyhydrazides; polyoxadiazoles; polytriazoles; poly(benzimidazole)s; polycarbodiimides; polyphosphazines; microporous polymers; and interpolymers, including block interpolymers containing repeating units from the above such as interpolymers of acrylonitrile-vinyl bromide-sodium salt of para-sulfophenylmethallyl ethers; and grafts and blends containing any of the foregoing. Typical substituents providing substituted polymers include halogens such as fluorine, chlorine and bromine; hydroxyl groups; lower alkyl groups; lower alkoxy groups; monocyclic aryl; lower acryl groups and the like.

Some preferred polymers that can serve as the continuous polymer matrix include, but are not limited to, polysulfones, sulfonated polysulfones, polyethersulfones (PESs), sulfonated PESs, polyethers, polyetherimides such as Ultem (or Ultem 1000) sold under the trademark Ultem®, manufactured by Sabic Innovative Plastics, cellulosic polymers such as cellulose acetate and cellulose triacetate, polyamides; polyimides such as Matrimid sold under the trademark Matrimid® by Huntsman Advanced Materials (Matrimid® 5218 refers to a particular polyimide polymer sold under the trademark Matrimid®), P84 or P84HT sold under the tradename P84 and P84HT respectively from HP Polymers GmbH, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediamine] (poly(6FDA-m-PDA)), poly[2,2′-bis-(3,4-dicarboxyphenyl)hexafluoropropane dianhydride-1,3-phenylenediamine-3,5-diaminobenzoic acid)] (poly(6FDA-m-PDA-DABA)); polyamide/imides; polyketones, polyether ketones; and microporous polymers.

The most preferred polymers that can serve as the continuous polymer matrix include, but are not limited to, polyimides such as Matrimid®, P84®, poly(BTDA-PMDA-TMMDA), poly(BTDA-PMDA-ODPA-TMMDA), poly(DSDA-TMMDA), poly(BTDA-TMMDA), or poly(DSDA-PMDA-TMMDA), polyetherimides such as Ultem®, polyethersulfones, polysulfones, cellulose acetate, cellulose triacetate, poly(vinyl alcohol)s, and microporous polymers.

Microporous polymers (or as so-called “polymers of intrinsic microporosity”) described herein are polymeric materials that possess microporosity that is intrinsic to their molecular structures. See McKeown, et al., CHEM. COMMUN., 2780 (2002); Budd, et al., ADV. MATER., 16:456 (2004); McKeown, et al., CHEM. EUR. J., 11:2610 (2005). This type of microporous polymers can be used as the continuous polymer matrix in MMMs in the current invention. The microporous polymers have a rigid rod-like, randomly contorted structure to generate intrinsic microporosity. These microporous polymers exhibit behavior analogous to that of conventional microporous molecular sieve materials, such as large and accessible surface areas, interconnected intrinsic micropores of less than 2 nm in size, as well as high chemical and thermal stability, but, in addition, possess properties of conventional polymers such as good solubility and easy processability. Moreover, these microporous polymers possess polyether polymer chains that have favorable interaction between carbon dioxide and the ethers.

The solvents used for dispersing the molecular sieve particles and for dissolving the polymers are chosen primarily for their ability to completely dissolve the polymers and for ease of solvent removal in the membrane formation steps. Other considerations in the selection of solvents include low toxicity, low corrosive activity, low environmental hazard potential, availability and cost. Representative solvents for use in this invention include most amide solvents that are typically used for the formation of polymeric membranes, such as N-methylpyrrolidone (NMP) and N,N-dimethyl acetamide (DMAC), methylene chloride, THF, acetone, DMF, DMSO, toluene, dioxanes, 1,3-dioxolane, mixtures thereof, others known to those skilled in the art and mixtures thereof.

Preferred materials used for coating the selective layer surface of the MMMs as described in the current invention include fluoro-polymers, thermally curable silicone rubbers, or UV radiation curable silicone rubbers containing UV curable functional groups such as epoxy or carbonyl groups.

A preferred temperature range for the final post heat treatment step when making the MMMs as described in the current invention is from 150° to 300° C. This post heat treatment can be performed for a certain time from 1 hour to 6 hours in vacuum, N₂, or air.

The method of the present invention for producing high performance MMMs is suitable for large scale membrane production and can be integrated into commercial polymer membrane manufacturing process.

The current invention provides a process for separating at least one gas from a mixture of gases using the MMMs described in the present invention, the process comprising: (a) providing a MMM comprising a polymer functionalized molecular sieve filler material dispersed in a continuous polymer matrix which is permeable to said at least one gas; (b) contacting the mixture on one side of the MMM to cause said at least one gas to permeate the MMM; and (c) removing from the opposite side of the membrane a permeate gas composition comprising a portion of said at least one gas which permeated said membrane.

The MMMs described in the present invention are suitable for a variety of liquid, gas, and vapor separations such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin (e.g. propylene/propane), iso/normal paraffins separations, and other light gas mixture separations.

The MMMs of the present invention are especially useful in the purification, separation or adsorption of a particular species in the liquid or gas phase. In addition to separation of pairs of gases, these MMMs may, for example, be used for the separation of proteins or other thermally unstable compounds, e.g. in the pharmaceutical and biotechnology industries. The MMMs may also be used in fermenters and bioreactors to transport gases into the reaction vessel and transfer cell culture medium out of the vessel. Additionally, the MMMs may be used for the removal of microorganisms from air or water streams, water purification, or ethanol production in a continuous fermentation/membrane pervaporation system, and in detection or removal of trace compounds or metal salts in air or water streams.

The MMMs of the present invention are especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of CO₂ from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the MMMs described herein. More than two gases can be removed from a third gas. For example, some of the gas components which can be selectively removed from a raw natural gas using the membrane described herein include carbon dioxide, oxygen, nitrogen, water vapor, hydrogen sulfide, helium, and other trace gases. Some of the gas components that can be selectively retained include hydrocarbon gases.

The MMMs described in the current invention are also especially useful in gas/vapor separation processes in chemical, petrochemical, pharmaceutical and allied industries for removing organic vapors from gas streams, e.g. in off-gas treatment for recovery of volatile organic compounds to meet clean air regulations, or within process streams in production plants so that valuable compounds (e.g., vinylchloride monomer, propylene) may be recovered. Further examples of gas/vapor separation processes in which these MMMs may be used are hydrocarbon vapor separation from hydrogen in oil and gas refineries, for hydrocarbon dew pointing of natural gas (i.e. to decrease the hydrocarbon dew point to below the lowest possible export pipeline temperature so that liquid hydrocarbons do not separate in the pipeline), for control of methane number in fuel gas for gas engines and gas turbines, and for gasoline recovery. The MMMs may incorporate a species that adsorbs strongly to certain gases (e.g. cobalt porphyrins or phthalocyanines for O₂ or silver(I) for ethane) to facilitate their transport across the membrane.

These MMMs may also be used in the separation of liquid mixtures by pervaporation, such as in the removal of organic compounds (e.g., alcohols, phenols, chlorinated hydrocarbons, pyridines, ketones) from water such as aqueous effluents or process fluids. A membrane which is ethanol-selective would be used to increase the ethanol concentration in relatively dilute ethanol solutions (5-10% ethanol) obtained by fermentation processes. Another liquid phase separation example using these MMMs is the deep desulfurization of gasoline and diesel fuels by a pervaporation membrane process similar to the process described in U.S. Pat. No. 7,048,846, incorporated by reference herein in its entirety. The MMMs that are selective to sulfur-containing molecules would be used to selectively remove sulfur-containing molecules from fluid catalytic cracking (FCC) and other naphtha hydrocarbon streams. Further liquid phase examples include the separation of one organic component from another organic component, e.g. to separate isomers of organic compounds. Mixtures of organic compounds which may be separated using an inventive membrane include: ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.

The MMMs may be used for separation of organic molecules from water (e.g. ethanol and/or phenol from water by pervaporation) and removal of metal and other organic compounds from water.

An additional application of the MMMs is in chemical reactors to enhance the yield of equilibrium-limited reactions by selective removal of a specific product in an analogous fashion to the use of hydrophilic membranes to enhance esterification yield by the removal of water.

### EXAMPLES

The following examples are provided to illustrate one or more preferred embodiments of the invention, but are not limited embodiments thereof. Numerous variations can be made to the following examples that lie within the scope of the invention.

### Example 1

A “control” 30% AlPO-14/PES/poly(DSDA-PMDA-TMMDA) asymmetric flat sheet MMM (abbreviated as AlPO-14/P MMM1) was prepared. 3.0 g of AlPO-14 molecular sieves were dispersed in a mixture of 14.0 g of NMP and 20 g of 1,3-dioxolane by mechanical stirring for 1 hour and then ultrasonication for 20 min to form a slurry. Then 2.0 g of PES was added to functionalize AlPO-14 molecular sieves in the slurry. The slurry was stirred for at least 1 hour and then ultrasonicated for 20 min to completely dissolve PES polymer and functionalize the surface of AlPO-14. After that, 5.0 g of poly(DSDA-PMDA-TMMDA) polyimide polymer and 3.0 g of PES polymer were added to the slurry and the resulting mixture was stirred for another 1 hour. Then a mixture of 5.0 g of acetone, 5.0 g of isopropanol, and 1.0 g of octane was added and the mixture was mechanically stirred for another 2 hours to form a stable MMM casting dope containing 30 wt-% of dispersed AlPO-14 molecular sieves in the continuous poly(DSDA-PMDA-TMMDA) and PES blend polymer matrix (weight ratio of AlPO-14 to poly(DSDA-PMDA-TMMDA) and PES is 30:100; weight ratio of PES to poly(DSDA-PMDA-TMMDA) is 1:1). The stable MMM casting dope was allowed to degas overnight.

An asymmetric flat sheet AlPO-14/P MMM1 was prepared by casting a thin layer of the bubble free MMM casting dope on a non-woven fabric substrate using a doctor knife with a 10-mil gap. The thin layer of the MMM casting dope was evaporated for 20 seconds and then the thin layer of the MMM casting dope together with the fabric substrate was immersed in a DI water bath at 0° to 2° C. for 10 minutes to create asymmetric membrane structure by phase inversion, and then immersed in a DI water bath at 86° C. for another 10 minutes to remove the residual solvents. The resulting wet asymmetric flat sheet membrane was dried at 80° to 85° C. in an oven for 2 hours to completely remove the solvents and the water. The dried membrane was then coated with a thermally cross-linkable silicon rubber solution (RTV615A+B Silicon Rubber from Momentive Performance Materials) containing 9 wt-% RTV615A and 1 wt-% RTV615B catalyst and 90 wt-% cyclohexane solvent). The RTV615A+B coated membrane was cured at 85° C. for 2 hours in an oven to cross-linked RTV615A+B silicon coating and form the final AlPO-14/P MMM1 membrane.

### Example 2

A 30% AlPO-14/PES/poly(DSDA-PMDA-TMMDA) asymmetric flat sheet MMM (abbreviated as AlPO-14/P MMM2) was prepared. 3.0 g of AlPO-14 molecular sieves were dispersed in a mixture of 14.0 g of NMP and 20 g of 1,3-dioxolane by mechanical stirring for 1 hour and then ultrasonication for 20 minutes to form a slurry. Then 2.0 g of PES was added to functionalize AlPO-14 molecular sieves in the slurry. The slurry was stirred for at least 1 hour and then ultrasonicated for 20 minutes to completely dissolve the PES polymer and functionalize the surface of AlPO-14. After that, 5.0 g of poly(DSDA-PMDA-TMMDA) polyimide polymer and 3.0 g of PES polymer were added to the slurry and the resulting mixture was stirred for another 1 hour. Then a mixture of 5.0 g of acetone, 5.0 g of isopropanol, and 1.0 g of octane was added and the mixture was mechanically stirred for another 2 hours to form a stable MMM casting dope containing 30 wt-% of dispersed AlPO-14 molecular sieves in the continuous poly(DSDA-PMDA-TMMDA) and PES blend polymer matrix (weight ratio of AlPO-14 to poly(DSDA-PMDA-TMMDA) and PES is 30:100; weight ratio of PES to poly(DSDA-PMDA-TMMDA) is 1:1). The stable MMM casting dope was allowed to degas overnight.

An asymmetric flat sheet AlPO-14/P MMM2 was prepared by casting a thin layer of the bubble free MMM casting dope on a non-woven fabric substrate using a doctor knife with a 10-mil gap. The thin layer of the MMM casting dope was evaporated for 20 seconds and then the thin layer of the MMM casting dope together with the fabric substrate was immersed in a DI water bath at 0° to 2° C. for 10 minutes to create an asymmetric membrane structure by phase inversion, and then immersed in a DI water bath at 86° C. for another 10 min to remove the residual solvents. The resulting wet asymmetric flat sheet membrane was dried at 80° to 85° C. in an oven for 2 hours to completely remove the solvents and the water. The dried membrane was then coated with a thermally cross-linkable silicon rubber solution (RTV615A+B Silicon Rubber from Momentive Performance Materials) containing 9 wt-% RTV615A and 1 wt-% RTV615B catalyst and 90 wt-% cyclohexane solvent). The RTV615A+B coated membrane was cured at 85° C. for 2 hours in an oven to cross-linked RTV615A+B silicon coating. Then the membrane was heat treated at 200° C. for 2 hours in vacuum oven to form the final AlPO-14/P MMM2 membrane.

### Example 3

CO₂/CH₄ gas separation properties of “Control” AlPO-14/P MMM1 and AlPO-14/P MMM2 mixed matrix membranes were determined. A “control” asymmetric flat sheet mixed matrix membrane AlPO-14/P MMM1 was prepared in Example 1. To eliminate the delamination between the thin coating layer and the thin selective mixed matrix layer and to further reduce the microvoids between polymer and molecular sieve particles, an asymmetric flat sheet mixed matrix membrane AlPO-14/P MMM2 was prepared using the novel method described in the present invention by adding an additional post heat treatment step to the membrane fabrication procedure as described in Example 2.

The CO₂ and CH₄ permeances and CO₂/CH₄ selectivities of these membranes were determined from high pressure mixed gas measurements under 6900 kPa (1000 psig) mixed gas pressure with 10% CO₂ at 50° C. Table 1 summarizes the permeation results. It can be seen from Table 1 that AlPO-14/P MMM2 membrane exhibited 40% increase in α_{CO2/CH4} compared to the “control” AlPO-14/P MMM1 membrane under 6900 kPa (1000 psig) pressure at 50° C. CO₂ permeance (P_{CO2}/l) of AlPO-14/P MMM2 decreased in the meantime due to the densification of the selective layer. These results demonstrated that post heat treatment after a one-step silicon coating on the selective layer of the mixed matrix membranes is an effective method to eliminate the delamination between the thin coating layer and the thin selective mixed matrix layer and to further reduce the microvoids and defects in the thin dense selective layer.

TABLE 1
High pressure mixed gas permeation test results for AlPO-14/P
MMM1 and AlPO-14/P MMM2 asymmetric flat sheet MMMs
for CO₂/CH₄ separation^{a}

| | P_{CO2}/l | | |
|---|---|---|---|
| Membrane | (A.U.)^{b} | α_{CO2/CH4} | Δα_{CO2/CH4} |
| AlPO-14/P MMM1^{a} | 7.04 | 11.8 | 0 |
| AlPO-14/P MMM2^{a} | 3.16 | 16.5 | 40% |

^{a}Tested at 50° C. under 6900 kPa (1000 psig) pressure of CO₂ and CH₄ mixed gas, 10% CO₂.
^{b}1 A.U. = 1 ft³ (STP)/h · ft² · 690 kPa (100 psi).

### Example 4

### Preparation of “Control” 30% AlPO-14/CA-CTA Mixed Matrix Dense Film (Abbreviated as AlPO-14/C MMM3)

2.4 g of AlPO-14 molecular sieves were dispersed in a mixture of 23.5 g of 1,4-dioxane and 10.0 g of acetone by mechanical stirring and ultrasonication for 1 hour to form a slurry. Then 4.0 g of cellulose triacetate (CTA) polymer was added to the slurry. The slurry was stirred for at least 2 hours to completely dissolve CTA polymer. After that, 4.0 g of cellulose acetate (CA) polymer was added to the slurry and the resulting mixture was stirred for another 2 hours to form a stable casting dope containing 30 wt-% of dispersed AlPO-14 molecular sieves (weight ratio of AlPO-14 to CA and CTA is 30:100; weight ratio of CA to CTA is 1:1) in the continuous CA-CTA polymer matrix. The stable casting dope was allowed to degas overnight.

A “control” 30% AlPO-14/CA-CTA mixed matrix dense film was prepared on a clean glass plate from the bubble free stable casting dope using a doctor knife with a 20-mil gap. The film together with the glass plate was then put into a vacuum oven. The solvents were removed by slowly increasing the vacuum and the temperature of the vacuum oven. Finally, the dense film was dried at 110° C. under vacuum for 48 hours to completely remove the residual solvents to form “control” 30% AlPO-14/CA-CTA mixed matrix dense film (abbreviated as AlPO-14/C MMM3 in Table 2).

### Example 5

### Preparation of 150° C. Heat-Treated 30% AlPO-14/CA-CTA Mixed Matrix Dense Film (Abbreviated as AlPO-14/MMM4-150 C)

A mixed matrix dense film AlPO-14/C MMM3 prepared in Example 4 was further heat-treated at 150° C. under vacuum for 24 hours to form AlPO-14/MMM4-150 C mixed matrix dense film.

### Example 6

### Preparation of 200° C. Heat-Treated 30% AlPO-14/CA-CTA Mixed Matrix Dense Film (Abbreviated as AlPO-14/MMM5-200 C)

A mixed matrix dense film AlPO-14/C MMM3 prepared in Example 4 was further heat-treated at 200° C. under vacuum for 24 hours to form AlPO-14/MMM5-200 C mixed matrix dense film.

### Example 7

### CO₂/CH₄ Gas Separation Property of AlPO-14/C MMM3, AlPO-14/MMM4-150 C, and AlPO-14/MMM5-200 C)

The CO₂ and CH₄ permeabilities and CO₂/CH₄ selectivities of the “control” mixed matrix dense film AlPO-14/C MMM3 prepared in Example 4, AlPO-14/MMM4-150 C prepared in Example 5, and AlPO-14/MMM5-200 C prepared in Example 6 were determined from pure gas measurements under 690 kPa (100 psig) pure gas pressure at 50° C. Table 2 summarizes the permeation results. It can be seen from Table 2 that AlPO-14/MMM4-150 C which was further heat-treated at 150° C. exhibited 15% increase in α_{CO2/CH4} compared to the “control” AlPO-14/C MMM3. AlPO-14/MMM5-200 C which was further heat-treated at 200° C. exhibited 23% increase in α_{CO2/CH4} compared to the “control” AlPO-14/C MMM3. These results demonstrate that post heat treatment after the formation of the mixed matrix membranes is an effective method to further improve the adhesion and reduce the microvoids and defects between the molecular sieve particles and the polymer matrix.

TABLE 2
Pure gas permeation test results for AlPO-14/C MMM3,
AlPO-14/MMM4-150C, and AlPO-14/MMM5-200C mixed matrix
dense films for CO₂/CH₄ separation^{a}

| | P_{CO2} | | |
|---|---|---|---|
| Membrane | (Barrer)^{b} | α_{CO2/CH4} | Δα_{CO2/CH4} |
| AlPO-14/C MMM3^{a} | 13.8 | 25.3 | 0 |
| AlPO-14/MMM4-150C^{a} | 12.6 | 29.1 | 15% |
| AlPO-14/MMM5-200C^{a} | 10.1 | 31.2 | 23% |

^{a}Tested at 50° C. under 690 kPa (100 psig) pressure of CO₂ and CH₄ pure gas.
^{b}1 Barrer = 1 cm³ (STP) · cm/cm² · sec · cmHg.

1. A method of making a mixed matrix membrane comprising:
(a) dispersing molecular sieve particles in a solvent mixture to form a molecular sieve slurry;
(b) dissolving a first polymer in the molecular sieve slurry to form a first polymer functionalized molecular sieve slurry, wherein said first polymer is used to functionalize the outer surface of the molecular sieve particles via covalent or hydrogen bonds;
(c) dissolving at least one second polymer in said first polymer functionalized molecular sieve slurry to form a stable first polymer functionalized molecular sieve/second polymer suspension, wherein said second polymer becomes a continuous second polymer matrix for said void free and defect free first polymer functionalized molecular sieve/second polymer mixed matrix membrane and wherein said first polymer and said second polymer are different polymers;
(d) fabricating a mixed matrix membrane using the stable first polymer functionalized molecular sieve/second polymer suspension; and
(e) heat treating said mixed matrix membrane at a temperature greater than or equal to 150° C.

2. The method of claim 1 wherein said heat treatment is at a temperature between about 150° C. to about 300° C.

3. The method of claim 1 wherein said first polymer is selected from the group consisting of polyethersulfones, sulfonated polyethersulfones, hydroxyl group-terminated poly(ethylene oxide)s, amino group-terminated poly(ethylene oxide)s, or isocyanate group-terminated poly(ethylene oxide)s, poly(esteramide-diisocyanate)s, hydroxyl group-terminated poly(propylene oxide)s, hydroxyl group-terminated co-block-poly(ethylene oxide)-poly(propylene oxide)s, hydroxyl group-terminated tri-block-poly(propylene oxide)-block-poly(ethylene oxide)-block-poly(propylene oxide)s, tri-block-poly(propylene glycol)-block-poly(ethylene glycol)-block-poly(propylene glycol) bis(2-aminopropyl ether), polyether ketones, poly(ethylene imine)s, poly(amidoamine)s, poly(vinyl alcohol)s, poly(allyl amine)s, poly(vinyl amine)s, and cellulosic polymers.

4. The method of claim 3 wherein said cellulosic polymers are selected from the group consisting of cellulose acetate, cellulose triacetate, cellulose acetate-butyrate, cellulose propionate, ethyl cellulose, methyl cellulose, and nitrocellulose.

5. The method of claim 1 wherein said first polymer is polyethersulfone.

6. The method of claim 1 wherein said void free and defect free first polymer functionalized molecular sieve/second polymer mixed matrix membrane has a carbon dioxide over methane selectivity of at least 15 at 50° C. under 690 kPa pure gas pressure.

7. The method of claim 1 wherein said second polymer is selected from the group consisting of polysulfones; polyetherimides; cellulosic polymers; polyamides; polyimides; polyamide/imides; polyether ketones; poly(ether ether ketone)s, poly(arylene oxides); poly(esteramide-diisocyanate); polyurethanes; poly(benzobenzimidazole); polyhydrazides; polyoxadiazoles; polytriazoles; poly(benzimidazole); polycarbodiimides; polyphosphazines; microporous polymers; and mixtures thereof.

8. The method of claim 1 wherein said second polymer is selected from the group consisting of polysulfone, polyetherimides, cellulose acetate, cellulose triacetate, polyamides, polyimides, P84 or P84HT, poly(3,3′,4,4′-benzophenone tetracarboxylic dianhydride-pyromellitic dianhydride-3,3′,5,5′-tetramethyl-4,4′-methylene dianiline), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline), poly(3,3′,4,4′-diphenylsulfone tetracarboxylic dianhydride-3,3′,5,5′-tetramethyl-4,4′-methylene dianiline), poly(3,3′,4,4′-benzophenone tetracarboxylic dianhydride-3,3′,5,5′-tetramethyl-4,4′-methylene dianiline), poly(3,3′,4,4′-diphenylsulfone tetracarboxylic dianhydride-pyromellitic dianhydride-3,3′,5,5′-tetramethyl-4,4′-methylene dianiline), poly[2,2′-bis-(3,4-dicarboxyphenyl)hexafluoropropane dianhydride-1,3-phenylenediamine], poly[2,2′-bis-(3,4-dicarboxyphenyl)hexafluoropropane dianhydride-1,3-phenylenediamine-3,5-diaminobenzoic acid)], poly(benzimidazole), and microporous polymers.

9. The method of claim 1 wherein said second polymer is selected from the group consisting of polyimides, polyetherimides, polyamides, cellulose acetate, cellulose triacetate, and microporous polymers.

10. The method of claim 1 wherein said mixed matrix membrane is a symmetric mixed matrix dense film, an asymmetric flat sheet mixed matrix membrane, an asymmetric thin film composite mixed matrix membrane, or an asymmetric hollow fiber mixed matrix membrane.

11. The method of claim 1 between step (d) and step (e) further comprising coating said mixed matrix membrane with a material selected from the group consisting of polysiloxanes, fluoropolymers, thermally curable silicone rubbers or UV radiation curable epoxysilicones.

12. The method of claim 1 wherein said molecular sieve is selected from the group consisting of microporous molecular sieves, mesoporous molecular sieves, carbon molecular sieves, and porous metal-organic frameworks.

13. The method of claim 12 wherein said microporous molecular sieves are small pore microporous molecular sieves selected from the group consisting of SAPO-34, Si-DDR, UZM-9, AlPO-14, AlPO-34, AlPO-17, AlPO-53, SSZ-62, SSZ-13, AlPO-18, UZM-25, ERS-12, CDS-1, MCM-65, MCM-47, 4A, 5A, UZM-5, UZM-9, SAPO-44, SAPO-47, SAPO-17, CVX-7, SAPO-35, SAPO-56, AlPO-52, SAPO-43; medium pore microporous molecular sieve silicalite-1; or large pore microporous molecular sieves selected from the group consisting of NaX, NaY, KY, CaY, and mixtures thereof.

14. The method of claim 1 wherein said mixed matrix membrane is used for a separation selected from the group consisting of deep desulfurization of gasoline or diesel fuels, ethanol/water separations, pervaporation dehydration of aqueous/organic mixtures, or gas separations.

15. The method of claim 1 wherein said gas separation comprises separating gases selected from the group consisting of CO₂/CH₄, CO₂/N₂, H₂/CH₄, O₂/N₂, olefin/paraffin (e.g. propylene/propane), iso/normal paraffins separations, and other light gas mixture separations.
